(19) United States
(12) Patent Application Publication
(10) Pub. No.: US 2020/0109275 A1
(43) Pub. Date: Apr. 9, 2020

(54) COLORANT COMPOSITION FOR A COLORED CONTACT LENS, A COLORED CONTACT LENS COMPRISING THE SAME AND A METHOD OF MODIFYING A COLORANT FOR A COLORED CONTACT LENS

(71) Applicant: BenQ Materials Corporation, Taoyuan (TW)

(72) Inventors: Fan-Dan Jan, Taoyuan City (TW); Hsia-Hao Chang, Taoyuan City (TW)

(21) Appl. No.: 16/254,614

(22) Filed: Jan. 23, 2019

(30) Foreign Application Priority Data
Oct. 3, 2018 (TW) 107134998

(51) Int. Cl. C08L 33/14; G02C 7/04; C09B 67/20; C09C 3/10

(52) U.S. Cl. CPC C08L 33/14; G02C 7/04; C08L 2205/03; C09C 3/10; C09B 67/0063

(57) ABSTRACT

The invention is related to a colorant composition used for the color layer in a colored contact lens. The colorant composition improves the adhesion of the colorant to the surface of the contact lens and provides more hydrophilicity and biocompatibility. The colorant composition for the color layer comprises at least one hydrophilic monomer, an adhesive resin, a film-forming agent and a polydopamine-modified colorant.

### CROSS-REFERENCE TO RELATED APPLICATION

This application claims the priority benefit of Taiwanese application serial No.107134998, filed on, Oct. 3, 2018, which is incorporated herein by reference.

### BACKGROUND OF THE INVENTION

### Field of the Invention

The present invention relates to a colorant composition for forming colored layer of the colored contact lens. The colorant composition can enhance the adhesion of the colored layer to the surface of the contact lens and provide good hydrophilic and biocompatible properties. The present invention further relates to a colored contact lens comprising the colorant composition and a method for modifying the colorant used in the colored contact lens.

### Description of Related Art

Nowadays, concerning fashion or clothes matching, people begin to wear colored contact lens capable of altering their natural iris color. However these different colored or patterned contact lens would fade or discolor so as to make the wearers have ocular allergy.

The common colored contact lens comprises a colored layer on the surface of a lens. The wearer will touch the surface of the lens during the process of wearing or cleaning the lens, the colored layer on the surface of the lens is likely to peeling off Therefore, the colorant may fall off and stick to the wearer's eye to cause the wearer's eye infection or allergies.

Another one of the conventional methods for manufacturing colored contact lens is to form a transparent layer is covered on the colored layer to protect the colored layer from being damaged and discolored. The transparent protective layer comprises a tackifying agent for reducing the colorant falling out. However,

Therefore, the present invention is to provide a colorant composition for forming the colored layer of the colored contact lens. The colorant composition has an excellent adhesion to the lens and exhibit hydrophilic and bio-compatibility. Furthermore, the colorant is adhered firmly so as to eliminate the protective layer for the colored layer and is favorable to the wear comfort of the colored silicon hydrogel contact lens.

### SUMMARY OF THE INVENTION

The present invention is to provide a colorant composition for a colored contact lens to form the colored layer thereof. The colorant composition can enhance the adhesion of the colored layer to the surface of the contact lens and provide good hydrophilic and biocompatible properties for the wearing comfort. The present colorant composition for colored contact lens comprises at least one of a hydrophilic monomer, a binder resin, a film forming agent and a polydopamine-modified colorant.

The another aspect of the present invention is to provide a method for modifying the colorant for the colored contact lens to enhance the adhesion between the colorant and the contact lens surface and thus to increase the wearing comfort thereof.

The present method for modifying the colorant used in the colored contact lens comprises the steps of: (a)providing dopamine in an alkaline aqueous solution to form a polydopamine solution; (b)adding a colorant for colored contact lens into the polydopamine solution and stirring thoroughly to enable the colorant and the polydopamine to react and form a solid-statepolydopamine-modified colorant; and (c)collecting the solid-state polydopamine-modified colorant.

The present invention is to provide a colored contact lens comprising a lens made of a hydrogel or a silicon hydrogeland a colored layer on one surface of the lens, wherein the colored layer is prepared by a colorant composition comprising at least one of a hydrophilic monomer, a binder resin, a film forming agent and a polydopamine-modified colorant.

In an embodiment of the colored contact lens of the present disclosure, the colorant composition for the colored layer further comprises an initiator, and/or a cross-linking agent, an/or an anti-blue ray reagent, and/or a UV reagent.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details.

It is apparent that departures from specific designs and methods described and shown will suggest themselves to those skilled in the art and may be used without departing from the spirit and scope of the invention. The present invention is not restricted to the particular constructions described and illustrated, but should be construed to cohere with all modifications that may fall within the scope of the appended claims.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

The present invention is to provide a colorant composition for a colored contact lens to form the colored layer thereof. The colorant composition can enhance the adhesion of the colored layer to the surface of the contact lens and provide good hydrophilic and biocompatible properties for the wearing comfort.

The colorant composition of the present disclosure for colored contact lens comprises a polydopamine-modified colorant. It is well known that dopamine has a molecular structure and strong adhesion property similar to mussel adhesive proteins. Dopamine contains lots of catechol and amine functional groups and also exhibits excellent biocompatible and hydrophilic properties. The present invention discloses a polydopamine-modify colorant for using in the colored contact lens to enhance the adhesion between the colorant and the contact lens surface and the wearing comfort thereof.

The present colorant composition for the colored contact lens comprises at least one of a hydrophilic monomer, a binder resin, a film forming agent and a polydopamine-modified colorant.

In an embodiment of the present disclosure, the hydrophilic monomers in the colorant composition for forming colored contact lens can be but not limited to, for example, selected from one of the group consisting of N-vinylpyrrolidone (NVP), 2-hydroxyethyl methacrylate (HEMA), N,N′-dimethylacrylamide (DMA), methyl acrylic acid (MAA), N,N′-diethylacrylamide, N-isopropylamide, 2-Hydroxypropyl acrylate, vinyl acetate, N-acrylolmorpholine and 2-dimethylaminoethyl acrylate, or combinations thereof. The present colorant composition is preferably to use two or more hydrophilic monomers. The amount of the hydrophilicmonomer is ranging from 20 weight percent to 45 weight percent relative to the total weight of the colorant composition, and preferably ranging from 25 weight percent to 40 weight percent relative to the total weight of the colorant composition.

The suitable binder resin used in the present colorant composition can be for example polyurethane, acrylic resin or phenolic resin. In a preferred embodiment of the present invention, the binder resin of the colored layer can be polyurethane with a viscosity in the range of 50,000cps to 150,000cps at 25° C., and preferably in the range of 80,000cps to 110,000cps at 25° C. For having a suitable viscosity of the colored layer, the amount of the binder resin is from 5 weight percent to 25 weight percent relative to the total weight of the colorant composition, and preferably ranging from 10 weight percent to 20 weight percent relative to the total weight of the colorant composition.

The suitable film forming agent used in the colorant composition of the present disclosure can be polyvinylpyrrolidone with a molecular weight ranging from 40,000g/mol to 80,000g/mol and k value (the viscosity in 1% aqueous solution) is ranging from 36 to 35. The film forming agent makes the surface of the colored layer smooth to prevent the colored layer from possible roughness caused by the polydopamine-modified colorant. For providing the colored layer with a sufficient film-forming characteristic, the amount of the film forming agent used in the composition is about 5 weight percent to 25 weight percent relative to the total amount of colorant composition.

The suitable polydopamine-modified colorant used in the colorant composition is prepared by the method of the present disclosure for modifying the colorant of the colored contact lens.

Another aspect of the present invention is to provide a method for modifying the colorant used in a colored contact lens. The method comprises the steps of: (a)providing dopamine in an alkaline aqueous solution to form a polydopamine solution; (b)adding a colorant for colored contact lens into the polydopamine solution and stirring thoroughly to enable the colorant and the polydopamine to react and form a solid-state polydopamine-modified colorant; and (c)collecting the solid-state polydopamine-modified colorant.

In an embodiment of the present method, the concentration of the polydopamine solution is between 50 ppm and 1500 ppm and preferably between 75 ppm and 1200 ppm.

The colorant can be the one commonly used in the related art, for example, organic colorant or inorganic colorant. The organic colorant can be, but not limited to, C.I. Reactive Yellow 14, C.I. Reactive Orange 7, C.I. Reactive Red 23 or C.I. Reactive Blue 19. The inorganic colorant can be, but not limited to, iron oxide black, iron oxide brown, iron oxide yellow, iron oxide red or titanium dioxide.

In an embodiment of the present colorant composition, when the coloring effect and the light transmittance of the contact lens are taken into consideration, the polydopamine-modified colorant is ranging from 10 weight percent to 60 weight percent relative to the total weight of the colorant composition, and preferably ranging from 30 weight percent to 50 weight percent relative to the total weight of the colorant composition.

In an embodiment of the present disclosure, the colorant composition further comprises an initiator, and/or a cross-linking agent, and/or an anti-blue ray reagent, and/or a UV reagent.

The initiator could be a photo initiator or a thermal initiator. The suitable thermal initiator can be but not limited to, for example, azobisisoheptonitrile (ADVN), 2,2′-azobisisobutyronitrile (AIBN), 2,2′-2,2′-azobis(2,4-dimethylvaleronitrile), (2,2′-azobis(2-methyl-propanenitrile), (2,2′-azobis(2-methyl-butanenitrile), or benzoyl peroxide. The photo initiator can be but not limited to, for example, 2,4,6-trimethylbenzoyl diphenyl oxide, 2-hydroxy-2-methylphenylpropane-l-one, ethyl (2,4,6-trimethylbenzoyl) phenylphosphinate, or 2,2-diethoxyacetophenone. The amount of the thermal initiator or the photo initiator used is ranging from 1 weight percent to 5 weight percent relative to the total weight of the colorant composition.

The suitable cross-linking agent used in the present colorant composition can be but not limited to, for example, selected from one of the group consisting of ethyl glycol dimethylacrylate (EGDMA), trimethylolpropanetriacrylate (TMPTA), triethylene glycol dimethacrylate (TrEGDMA), tetraethylene glycol dimethacrylate (TEGDMA), poly(ethylene glycol)dimethacryalte (PEGDMA), vinyl methacrylate, ethylenediamine dimethyl acrylamide, glycerol dimethacrylate, triallylisocyanurate and triallylcyanurate, or combinations thereof. The amount of the cross-linking agent used is ranging from 1 weight percent to 3 weight percent relative to the total weight of the colorant composition.

A further aspect of the present invention is to provide a colored contact lens. In an embodiment of the present invention, the colored contact lens comprises a contact lens made of hydrogel or silicon hydrogel; a colored layer on one surface of the contact lens, wherein the colored layer comprises a colorant composition comprising a hydrophilic monomer, a binder resin, a film forming agent and a polydopamine-modified colorant.

The following Examples are used to further describe the present invention rather than to limit thereto.

### EXAMPLE

### Preparation Example 1

### Preparation of the Polydopamine Solution

1 g of dopamine was dissolved in 1000 ml of aqueous sodium bicarbonate solution (pH 8.5) and stirred for 24 hours. The resulting polydopamine solution with a concentration of 1000 ppm was obtained.

### Preparation Example 2

### Preparation of the Polydopamine-Modified Colorant I

50 g black colorant (Sicovit Black 85E172, commercially obtained from BASF, Germany) was added into 100ml of 1000ppm polydopamine solution. The solution was mixed and stirred at room temperature for 24 hours and allowed it to stand until the precipitate was settled. The black precipitate was collected and dried in oven to obtain a polydopamine-modified colorant I.

### Preparation Example 3

### Preparation of the Polydopamine-Modified Colorant II

The polydopamine solution of Preparation Example 1 was diluted with sodium bicarbonate solution (pH 8.5) to 500 ppm. In accordance with the procedures of Preparation Example 2, 50 g black colorant and 100 ml of 500 ppm polydopamine solution were used to prepare polydopamine-modified colorant II.

### Preparation Example 4

### Preparation of the Polydopamine-Modified Colorant III

The concentration of the polydopamine solution of Preparation Example 1 was diluted with aqueous sodium bicarbonate solution (pH=8.5) to 10 ppm. In accordance with the procedures of Preparation Example 2, 50 g black colorant and 100 ml ppm polydopamine solution were used to prepare polydopamine-modified colorant III.

### Preparation Example 5

### Preparation of the Contact Lens Composition

4.44 g of isophoronediisocyanate, 0.0025 g of dibutyltindilaurate as catalysts and 40 mL of methylene chloride were added into a flask to form a solution, and the solution was stirred under a stream of nitrogen. Then, 20g of α-butyl-ω-[3-(2,2-(hydroxymethyl) butoxy) propyl] polydimethylsiloxane was accurately weighed and added dropwise to the solution over about 1 hour. After the solution reacting for 12 hours, the resulting reaction product was washed with a large amount of water, and then dehydrated and filtered to obtain a raw product. Then, the methylene chloride was evaporated to obtain a first polydimethyl siloxane macromer.

8.88 g of isophoronediisocyanate, 0.0025 g of dibutyltindilaurate as catalysts and 40 mL of methylene chloride were added into a flask to form a solution, and the solution was stirred under a stream of nitrogen. Then, 20 g of polydimethylsiloxane was accurately weighed and added dropwise to the solution over about 1 hour. After the solution reacting at room temperature for 12 hours, another 0.0025 g of dibutyltindilaurate and 14.4 g of polyethylene glycol monomethacrylate were accurately weighed and added dropwise to the solution over about 1 hour. After the solution reacting for another 12 hours, the resulting reaction product was washed with a large amount of water, and then dehydrated and filtered to obtain a raw product. Then, the methylene chloride was evaporated to obtain a second polydimethyl siloxane macromer.

41.8 g of the first polydimethyl siloxane macromer, 6.3 g of the second polydimethyl siloxane macromer, 0.7 g of azobisisoheptonitrile (ADVN), 46.96 g of N-vinylpyrrodine (NVP), 6.3 g of 2-hydroxyethyl methacrylate (HEMA), lg of ethylene glycol dimethylacrylate (EGDMA) and 25.1 g of hexanol were mixed and stirred about 1 hour to obtain a silicon hydrogel contact lens composition.

### Example 1

### Preparation of the Colored Contact Lens

27.27 g of 2-hydroxyethyl methacrylate (HEMA), 2.69 g of lauryl methacrylate (LMA), 1.20 g of N,N-dimethylacrylamide(DMA), 1.58 g of methacrylic acid (MAA), 11.09 g of polyurethane (trade name is AgiSyn 230 SM-Z90, and is available from Dsm-AGI Corp., Taiwan), 1.57 g of trimethylolpropanetriacrylate (trade name TMPTA, commercially obtained from Sigma-Aldrich, US), 15.0 g of polyvinylpyrrodine (trade name is PVP-k30, the weight average molecular weight is 40,000 and is available from Sigma-Aldrich, US), 2.0 g of a photo initiator, 2-hydroxy-2-methylpropiophenone (trade name is UV-1173, commercially obtained from BASF, Taiwan) and 37.6 g of polydopamine-modified colorant I (Preparation Example 2) were grinded by a ball mill (RETSCHPM 400) to form a colored layer composition.

The obtained colored layer composition was transferred to a polypropylene (PP) mold and photo-polymerized to make a colored layer. The silicon hydrogel contact lens composition obtained in Preparation Example 5 was quantitatively dropped in to the PP mole and cured at 80° C. for 5 hours, then at 115° C. for 2 hours. After the polymerization was completed, the mold was immersed in alcohol for 1 hour and the resulting molded lens was taken out of the mold. The resulting lens was conducted a hydration treatment to obtain the colored contact lens. The obtained colored contact lens was sterilized at 121° C. for 30 minutes.

Hydration procedure is as follows:
(a) soaking the lens in 80% alcohol for 1 hour, and taking out the lens;
(b) soaking the lens in 90% ethanol for 1 hour, and taking out the lens;
(c) immersing the lens in water and heating at 80° C. for 1 hour, and taking the lens; and
(d) balancing the lens in a buffer solution for 12 hours.

### Example 2

### Preparation of the Colored Contact Lens

The method for preparing the colored contact lens of the Example 2 was same as Example 1, except that the colorant used in the colored layer composition of Example 2 is the polydopamine-modified colorant II of the Preparation Example 3.

### Example 3

### Preparation of the Colored Contact Lens

The method for preparing the colored contact lens of the Example 3 was same as Example 1, except that the colorant used in the colored layer composition of Example 3 is the polydopamine-modified colorant III of Preparation Example 4.

### Comparative Example 1

### Preparation of the Colored Contact Lens

The method for preparing the colored contact lens of the Comparative Example 1 was same as Example 1, except that the colorant used in the colored layer composition is the non-modified black colorant (Brand name: Sicovit Black 85E172, commercially obtained from BASF, Germany)

The physical properties of the colored contact lens prepared from Example 1 to Example 3 and Comparative Example 1 were measured according to the following measuring method. The resulting data were listed in the Table 1.

### Physical Properties Determination

(A)Measurement of the Water Content

The contact lens was immersed in the phosphate buffered saline (PBS) at 23° C. for 24 hours. Then, the contact lens was removed therefrom and was taken to remove all surface water by a long-fiber fabric. After that, the weight of contact lens was measured. Next, the contact lens was dried at 600 W for 5 minutes by microwave and after that the weight of hydrated contact lens was measured. The water content of contact lens was calculated by the following equation: (the weight of hydrated contact lens−the weight of dried contact lens)/the weight of hydrated contact lens×100%.
(B)Measurement of Tensile Modulus, Tensile Strength and Elongation Ratio of Contact Lens

The test sample was cut from the middle area of a contact lens into a sample size of 10 mm. Then, the test sample was immersed in a buffer specified in ISO 18369-3 Section 4.7 at 25° C. for 2 hours. After that, in a condition of temperature of 20±5° C. and relative humidity of 55%±10%, the test sample was taken to remove all surface water by a long-fiber fabric and be conducted to proceed tensile modulus and tensile strength measurement by using a test instrument, AI-3000 (available from Gotech Testing Maching Inc.). The measurement was carried out at a constant loading speed of 10 mm/min. The tensile modulus, tensile strength and elongation ratio were determined according to the initial gradient of the strain-stress curve.
(C)Measurement of Oxygen Permeability of Contact Lens(Dk)

The oxygen permeability (Dk) was measured according to ISO standards 18369-4:2006, 4.4.3, by using a oxygen permeability tester (201T). The units of oxygen permeability (Dk) is defined as 10⁻¹⁰ (ml O₂ mm)/cm²sec mm Hg.
(D)Evaluation of Deformation of Contact Lens

The appearance of the contact lens was observed visually to judge whether the deformation occurred or not.
(E)Evaluation of Discoloration of Contact Lens

The contact lens was put on a stage and a cotton swab was used to rub the surface of the contact lens for 40 times. In final, the surface of the cotton swab was observed visually to judge whether any color fading from the contact lens. “⊚” represents no color fading, “X” represents color fading

From the results shown in Table 1, it can be seen that the colored layer of Comparative Example 1 was faded after the discoloration test. The colored contact lens of Example 1 to Example 3, the colorant of the colored layer was polydopamine-modified colorant so as to provide a good coloring effect without fading and deformation of the lens.

TABLE 1
The test results of Examples1-3 and Comparative Example 1

| | Example | Example | Example | Comparative |
|---|---|---|---|---|
| Physical properties | 1 | 2 | 3 | Example 1 |
| Tensile Modulus (MPa) | 0.61 | 0.60 | 0.60 | 0.67 |
| Tensile Strength (g) | 40 | 38 | 38 | 34 |
| Elongation Ratio (%) | 68 | 70 | 70 | 74 |
| Water Content (%) | 46.6 | 47.0 | 46.0 | 46.6 |
| Oxygen Permeability | 121 | 120 | 120 | 120 |
| (Dk) | | | | |
| Deformation of | No | No | No | No |
| Contact Lens | | | | |
| Discoloration of | ⊚ | ⊚ | ⊚ | X |
| Contact Lens | | | | |

In the contact lens obtained in Examples 1 to 3, the water content is about 46.0% to 47.0%, the tensile modulus is from 0.60 MPa to 0.61 MPa, the tensile strength is from 38 g to 40 g, the elongate ratio is from 68% to 70% and the oxygen permeability (Dk) is about from 120-121. The physical properties of the contact lens obtainedfrom the Examples are satisfied.

While the invention has been described by way of example(s) and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A colorant composition for colored contact lens comprising at least one of a hydrophilic monomer, a binder resin, a film forming agent and a polydopamine-modified colorant.

2. The colorant composition as claimed in claim 1, wherein the colorant is a polydopamine-modified organic or inorganic colorant.

3. The colorant composition as claimed in claim 2, wherein the inorganic colorant is iron oxide black, iron oxide brown, iron oxide yellow, iron oxide red or titanium dioxide.

4. The colorant composition as claimed in claim 2, wherein the organic colorant is C.I. Reactive Yellow 14, C.I. Reactive Orange 7, C.I. Reactive Red 23 or C.I. Reactive Blue 19.

5. The colorant composition as claimed in claim 1, wherein the polydopamine-modified colorant is prepared by the method comprising the following steps of:
(a) providing dopamine in an alkaline aqueous solution to form a polydopamine solution;
(b) adding a colorant for colored contact lens into the polydopamine solution and stirring thoroughly to enable the colorant and the polydopamine to react and form a solid-state polydopamine-modified colorant; and
(c) collecting the solid-state polydopamine-modified colorant.

6. The colorant composition as claimed in claim 1, wherein the amount of the polydopamine-modified colorant is ranging from 10 weight percent to 60 weight percent relative to the total weight of the colorant composition.

7. The colorant composition as claimed in claim 1, wherein the amount of the polydopamine-modified colorant is ranging from 30 weight percent to 50 weight percent relative to the total weight of the colorant composition.

8. The colorant composition as claimed in claim 1, wherein the hydrophilic monomer is selected from at least one of the group consisting of N-vinylpyrrolidone (NVP), 2-hydroxyethyl methacrylate (HEMA), N,N′-dimethylacrylamide (DMA), methyl acrylic acid (MAA), N,N′-diethylacrylamide, N-isopropylamide, 2-Hydroxypropyl acrylate, vinyl acetate, N-acrylolmorpholine and 2-dimethylaminoethyl acrylate, or combinations thereof.

9. The colorant composition as claimed in claim 1, wherein the film forming agent comprises polyvinylpyrrolidone.

10. The colorant composition as claimed in claim 1, wherein the binder resin is selected from at least one of the group consisting of polyurethane, acrylic resin and phenolic resin,or combinations thereof.

11. The colorant composition as claimed in claim 1 further comprising an initiator, and/or a cross-linking agent, and/or an anti-blue ray reagent, and/or a UV reagent.

12. A method for modifying the colorant used in a colored contact lens comprising the steps of:
(a)providing dopamine in an alkaline aqueous solution to form a polydopamine solution;
(b) adding a colorant for colored contact lens into the polydopamine solution and stirring thoroughly to enable the colorant and the polydopamine to react and form a solid-state polydopamine-modified colorant; and
(c)collecting the solid-state polydopamine-modified colorant.

13. The method as claimed in claim 12, wherein the concentration of the polydopamine solution is ranging from 50 ppm to 1500 ppm.

14. The method as claimed in claim 12, wherein the concentration of the polydopamine solution is ranging from 75 ppm to 1200 ppm.

15. The method as claimed in claim 12, wherein the colorant is organic or inorganic colorant.

16. The method as claimed in claim 15, wherein the organic colorant comprises C.I. Reactive Yellow 14, C.I. Reactive Orange 7, C.I. Reactive Red 23 or C.I. Reactive Blue 19.

17. The method as claimed in claim 15, wherein the inorganic colorant comprises iron oxide black, iron oxide brown, iron oxide yellow, iron oxide red or titanium dioxide.

18. A colored contact lens comprising:
a contact lens made of hydrogel or silicon hydrogel; and
a colored layer on one surface of the contact lens, wherein the colored layer comprises a colorant composition comprising at least one of a hydrophilic monomer, a binder resin, a film forming agent and a polydopamine-modified colorant.

19. The colored contact lens as claimed in claim 18, wherein the colorant is a polydopamine-modified organic or inorganic colorant.

20. The colored contact lens as claimed in claim 19, wherein the inorganic colorant is iron oxide black, iron oxide brown, iron oxide yellow, iron oxide red or titanium dioxide.

21. The colored contact lens as claimed in claim 19, wherein the organic colorant is C.I. Reactive Yellow 14, C.I. Reactive Orange 7, C.I. Reactive Red 23 or C.I. Reactive Blue 19.

22. The colored contact lens as claimed in claim 18, wherein the polydopamine-modified colorant is prepared by the method comprising the following steps of:
(a) providing dopamine in an alkaline aqueous solution to form a polydopamine solution;
(b) adding a colorant for colored contact lens into the polydopamine solution and stirring thoroughly to enable the colorant and the polydopamine to react and form a solid-state polydopamine-modified colorant; and
(c) collecting the solid-state polydopamine-modified colorant.

23. The colored contact lens as claimed in claim 18, wherein the amount of the polydopamine-modified colorant is ranging from 10 weight percent to 60 weight percent relative to the total weight of the colorant composition.

24. The colored contact lens as claimed in claim 18, wherein the amount of the polydopamine-modified colorant is ranging from 30 weight percent to 50 weight percent relative to the total weight of the colorant composition.

25. The colored contact lens as claimed in claim 18, wherein the hydrophilic monomer is selected from at least one of the group consisting of N-vinylpyrrolidone (NVP), 2-hydroxyethyl methacrylate (HEMA), N,N′-dimethylacrylamide (DMA), methyl acrylic acid (MAA), N,N′-diethylacrylamide, N-isopropylamide, 2-Hydroxypropyl acrylate, vinyl acetate, N-acrylolmorpholine and 2-dimethylaminoethyl acrylate, or combinations thereof.

26. The colored contact lens as claimed in claim 18, wherein the film forming agent comprises polyvinylpyrrolidone.

27. The colored contact lens as claimed in claim 18, wherein the binder resin is selected from at least one of the group consisting of polyurethane, acrylic resin and phenolic resin,or combinations thereof.

28. The colored contact lens as claimed in claim 18 further comprising an initiator, and/or a cross-linking agent, and/or an anti-blue ray reagent, and/or a UV reagent.
